(19) United States
(12) Patent Application Publication
(10) Pub. No.: US 2022/0356550 A1
(43) Pub. Date: Nov. 10, 2022

(54) HIGH-CHROMIUM WHITE IRON ALLOY COMPRISING RARE-EARTH

(71) Applicant: AB Bruzaholms Bruk, Bruzaholm (SE)

(72) Inventors: Henrik BORGSTRÖM, Jonkoping (SE); Stefan VIRTANEN, Nassjo (SE); Hans KARLSSON, Bruzaholm (SE); Sören JOHANNSON, Bruzaholm (SE)

(21) Appl. No.: 17/830,230

(22) Filed: Jun. 1, 2022

Related U.S. Application Data
(63) Continuation of application No. PCT/SE2020/051144, filed on Nov. 30, 2020.

(30) Foreign Application Priority Data
Dec. 5, 2019 (SE) 1951403-3

(51) Int. Cl. C22C 38/44; C22C 38/00; C22C 38/02; C22C 38/04; C22C 1/02

(52) U.S. Cl. CPC C22C 38/44; C22C 38/005; C22C 38/02; C22C 38/04; C22C 1/02

(57) ABSTRACT

The present disclosure relates to a high-chromium white iron alloy comprising rare-earth (RE) element. The alloy comprises RE of 0.01-0.6 wt %, Cr of 26-30 wt %, C of 2.5-4 wt %, Si of 0.2-2 wt %, Mn of 0.5-1 wt %, Mo of 0.2-0.5 wt %, Ni of 0.01-0.6 wt %, at most 1 wt % of impurities, and a balance of Fe. The invention also relates to a white iron product made from the alloy. Further, the invention relates to a method comprising adding an RE powder to a metal melt comprising Cr, C, Si, Mn, Mo, Ni and Fe as above, whereby a white iron alloy melt comprising RE is formed.

### RELATED APPLICATIONS

This application is a continuation application of PCT Application No. PCT/SE2020/051144, filed Nov. 30, 2020 which claims the benefit of, and priority to, Swedish Patent Application No. SE 1951403-3, filed Dec. 5, 2019, both of which are incorporated by reference in herein in their entireties.

### TECHNICAL FIELD

The present disclosure relates to a high-chromium white iron alloy.

### BACKGROUND

High-chromium white iron alloys are generally known. However, a problem is often the rather large carbide crystals formed within the alloy, which may also not be evenly dispersed, increasing the brittleness of the alloy product.

### SUMMARY

It is an objective of the present invention to provide an improved white iron alloy.

According to an aspect of the present invention, there is provided a high-chromium white iron alloy comprising rare-earth (RE) element. The alloy comprises RE of 0.01-0.6 wt %, Cr of 26-30 wt %, C of 2.5-4 wt %, Si of 0.2-2 wt %, Mn of 0.5-1 wt %, Mo of 0.2-0.5 wt %, Ni of 0.01-0.6 wt %, at most 1 wt % of impurities, and a balance of Fe.

According to another aspect of the present invention, there is provided a method of preparing a high-chromium white iron alloy comprising RE element. The method comprises adding an RE powder to a metal melt whereby a white iron alloy melt comprising RE is formed. The alloy melt comprises RE of 0.01-0.6 wt %, Cr of 26-30 wt %, C of 2.5-4 wt %, Si of 0.2-2 wt %, Mn of 0.5-1 wt %, Mo of 0.2-0.5 wt %, Ni of 0.01-0.6 wt %, at most 1 wt % of impurities, and a balance of Fe.

According to another aspect of the present invention, there is provided a white iron product made from an embodiment of the alloy, or alloy melt, of the present disclosure, wherein the white iron product is or comprises any of a dispersing disc, a grinding disc, a refiner disc, an abrasion resistant plate, a mixing blade, a mixing arm or a cutting blade, preferably a dispersing disc, a grinding disc or a refiner disc, most preferably a dispersing disc.

The at most 1 wt % of impurities typically comprises a plurality of compounds other than those specified herein as part of the alloy or alloy melt, such as copper (Cu) resulting from using scrap metal as an iron source. Each of said compounds of impurity, e.g. Cu, is typically present in an amount of less than 0.5 wt %, less than 0.2 wt %, less than 0.1 wt % or less than 0.05 wt % of the alloy or alloy melt.

It has now been found by the inventors that the inclusion of RE in an amount within the range of 0.01-0.6 wt % in the alloy results in finer and more well dispersed carbide crystal structures. The carbide crystals are more rounded and thus prevent crack formation in the alloy product. The high chromium content of the present invention results mainly in M₇C₃ carbides (where M is metal, here typically Fe or Cr) being formed, e.g. Fe₇C₃ and/or Cr₇C₃ carbide formation, especially Cr₇C₃ carbide formation. Thus, an effect of the RE used in accordance with the present invention is more rounded carbide crystal structures, where the carbide is mainly comprised of M₇C₃ carbides.

Different chromium carbides are formed at different chromium contents of an alloy. In steel alloys with up to about 13 wt % Cr, Cr substitutes Fe in the carbide phase cementite (M₃C, where M is metal, typically Fe or Cr). At higher Cr content, another carbide phase (M₇C₃) is formed with Cr, i.e. Cr₇C₃. Cr₇C₃ has a more compact structure than cementite and thus a higher hardness and impact strength.

For embodiments of the present invention, the Cr₇C₃ carbides are desired and the properties of the inventive alloy are improved by the rounding of the Cr₇C₃ carbides provided by the presence of RE. However, when the Cr content is further increased, e.g. above the range of 26-30 wt % and especially above about 35 wt %, the carbide phase may be too dominant in the alloy, making it brittle. Further, for even higher Cr content, especially above 40 wt % Cr, the undesirable carbide phase Cr₂₃C₆, which is softer and more brittle than Cr₇C₃, is formed. Since the Cr content in the alloy may typically not be completely homogenous during forming thereof, parts having a Cr content of 40 wt % or more may be formed also where the overall Cr content is lower, such as above 30 wt %.

Thus, it has now been found that a Cr content within the range of 26-30 wt %, in combination with an RE content within the range of 0.01-0.6 wt %, results in an alloy comprising the desired carbide Cr₇C₃ in a suitable amount and with the Cr₇C₃ carbides being rounded by the RE present, preventing the formation of cracks. Also, compared with an even higher Cr content, the alloy is harder and stronger, with reduced risk of brittleness resulting from too much carbide phase and/or from presence of undesired Cr₂₃C₆ carbides.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein.

### DETAILED DESCRIPTION

Embodiments will now be described more fully hereinafter. However, other embodiments in many different forms are possible within the scope of the present disclosure. Rather, the following embodiments are provided by way of example so that this disclosure will be thorough and complete, and will fully convey the scope of the disclosure to those skilled in the art.

In some embodiments, the amount of RE in the alloy, product or alloy melt is within the range of 0.05-0.6 wt % or 0.1-0.5 wt %, preferably within the range of 0.2-0.4 wt % which may be a preferred range in some embodiments.

In some embodiments, the amount of chromium (Cr) in the alloy, product or alloy melt is within the range of 27-29 wt %, which may be a preferred range in some embodiments.

In some embodiments, the amount of carbon (C) in the alloy, product or alloy melt is within the range of 2.5-3.2 wt %, which may be a preferred range in some embodiments.

In some embodiments, the amount of silicon (Si) in the alloy, product or alloy melt is within the range of 0.3-1 wt %, which may be a preferred range in some embodiments.

In some embodiments, the amount of manganese (Mn) in the alloy, product or alloy melt is within the range of 0.8-1 wt %, which may be a preferred range in some embodiments.

In some embodiments, the amount of molybdenum (Mo) in the alloy, product or alloy melt is within the range of 0.4-0.5 wt %, which may be a preferred range in some embodiments.

In some embodiments, the amount of nickel (Ni) in the alloy, product or alloy melt is within the range of 0.2-0.4 wt %, which may be a preferred range in some embodiments.

There is typically a small amount of inevitable impurities in the alloy, product or alloy melt, e.g. if the iron (Fe) is from scrap metal. The amount of impurities is preferably at most 1 wt %. The at most 1 wt % of impurities typically comprises a plurality of compounds other than those specifically specified herein as part of the alloy or alloy melt, e.g. copper (Cu) resulting from using scrap metal as an iron source. Each of said compounds comprised in the at most 1 wt % of impurities, e.g. Cu, is typically present in an amount of less than 0.5 wt % or less than 0.2 wt %, preferably less than 0.1 wt % or less than 0.05 wt % of the alloy or alloy melt.

In some embodiments, the RE comprises or consists of cerium (Ce), lanthanum (La) and/or yttrium (Y), preferably Ce (which is easily obtainable).

The balance of the alloy, product or alloy melt is Fe. In some embodiments, the alloy, product or alloy melt comprises Fe within the range of 60-70 wt %.

RE powder is added to the metal melt to produce the alloy melt of the present disclosure. The RE powder may have a particle size distribution between 0.2 and 7 mm. The RE powder may have an RE content within the range of 25-40 wt %. The RE powder may comprise or consist of so called mischmetal.

The alloy melt may be used for casting a product, to obtain a white iron product. The casting is preferably by line forming, shell forming, hand forming or by 3D-printed moulds or cores. Line forming may be preferred, but shell forming has been seen to give primary austenite formation which may be desirable in some embodiments.

In some embodiments, the white iron product is or comprises any of a dispersing disc, a grinding disc, a refiner disc, an abrasion resistant plate, a mixing blade, a mixing arm or a cutting blade, preferably a dispersing disc, a grinding disc or a refiner disc, most preferably a dispersing disc.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A high-chromium white iron alloy comprising a rare-earth (RE) element, the high-chromium white iron alloy containing:
RE: 0.01-0.6 wt %,
Cr: 26-30 wt %,
C: 2.5-4 wt %,
Si: 0.2-2 wt %,
Mn: 0.5-1 wt %,
Mo: 0.2-0.5 wt %,
Ni: 0.01-0.6 wt %,
at most 1 wt % of impurities, and
a balance of Fe.

2. The high-chromium white iron alloy of claim 1, wherein the RE element comprises Ce, La and Y.

3. The high-chromium white iron alloy of claim 1, containing Fe within the range of 60-70 wt %.

4. A method of preparing a high-chromium white iron alloy comprising rare-earth (RE) element, the method comprising:
adding an RE powder to a metal melt whereby a white iron alloy melt comprising RE is formed, the white iron alloy melt containing:
RE: 0.01-0.6 wt %,
Cr: 26-30 wt %,
C: 2.5-4 wt %,
Si: 0.2-2 wt %,
Mn: 0.5-1 wt %,
Mo: 0.2-0.5 wt %,
Ni: 0.01-0.6 wt %,
at most 1 wt % of impurities, and
a balance of Fe.

5. The method of claim 4, wherein the RE powder has a particle size distribution between 0.2 and 7 mm.

6. The method of claim 4, wherein the RE powder has an RE content within the range of 25-40 wt %.

7. The method of claim 4, wherein the RE powder comprises mischmetal.

8. The method of claim 4, further comprising:
with the white iron alloy melt, casting a product by line forming, shell forming, hand forming or by 3D-printed moulds or cores, to obtain a white iron product.

9. The method of claim 4, wherein the white iron product is or comprises any of a dispersing disc, a grinding disc, a refiner disc, an abrasion resistant plate, a mixing blade, a mixing arm or a cutting blade.

10. A white iron product comprising a high-chromium white iron alloy containing a rare-earth (RE) element, the high-chromium white iron alloy containing:
RE: 0.01-0.6 wt %,
Cr: 26-30 wt %,
C: 2.5-4 wt %,
Si: 0.2-2 wt %,
Mn: 0.5-1 wt %,
Mo: 0.2-0.5 wt %,
Ni: 0.01-0.6 wt %,
at most 1 wt % of impurities, and
a balance of Fe.
wherein the white iron product is or comprises any of a dispersing disc, a grinding disc, a refiner disc, an abrasion resistant plate, a mixing blade, a mixing arm or a cutting blade.

11. The high-chromium white iron alloy of claim 1, containing:
RE: 0.2-0.4 wt %.

12. The high-chromium white iron alloy of claim 1, containing:
Cr: 27-29 wt %.

13. The high-chromium white iron alloy of claim 1, containing:
C: 2.5-3.2 wt %.

14. The high-chromium white iron alloy of claim 1, containing:
Si: 0.3-1 wt %.

15. The high-chromium white iron alloy of claim 1, containing:
Mn: 0.8-1 wt %.

16. The high-chromium white iron alloy of claim 1, containing:
Mo: 0.4-0.5 wt %.

17. The high-chromium white iron alloy of claim 1, containing:
Ni: 0.2-0.4 wt %.

18. The white iron product of claim 10, containing:
RE: 0.2-0.4 wt %.

19. The white iron product of claim 10, containing:
Cr: 27-29 wt %.

20. The white iron product of claim 10, containing:
C: 2.5-3.2 wt %.
